(19) United States
(12) Patent Application Publication
(10) Pub. No.: US 2017/0323084 A1
(43) Pub. Date: Nov. 9, 2017

(54) Determining an Apparent Molecular Weight for a Depth Interval for a Wellbore

(71) Applicant: Saudi Arabian Oil Company, Dhahran (SA)

(72) Inventors: Nasser M. Al-Hajri, Eastern Province (SA); Mohammed D. Al-Ajmi, AlKhobar (SA); Ahmed A. Homoud, Dhahran (SA)

(21) Appl. No.: 15/147,641

(22) Filed: May 5, 2016

(51) Int. Cl. G06F 19/00; G06F 17/50

(52) U.S. Cl. CPC G06F 19/704; G06F 17/5009

(57) ABSTRACT

An initial value is set for an apparent molecular weight. Iterating occurs on calculations to determine a converged value for the apparent molecular weight, including the following. A specific gas gravity is determined. Pseudo-critical gas properties are determined. A pseudo-reduced gas pressure and temperature are determined. A gas deviation factor is determined using the pseudo-reduced gas properties. An average pressure, an average temperate, and a pressure gradient are determined for each depth interval. A new apparent molecular weight is determined. The absolute value of a relative error between a current value of the apparent molecular weight and the new apparent molecular weight is determined. If the absolute value of the relative error has converged to a constant, the iterating is terminated.

### CROSS-REFERENCE TO RELATED APPLICATIONS

This application is related to our reference, Attorney Docket Number 38136-0144001, U.S. patent application Ser. No. ______, filed on ______. The entire contents of Attorney Docket Number 38136-0144001, U.S. patent application Ser. No. ______, are each hereby incorporated by reference in its entirety.

### BACKGROUND

For many decades, petroleum engineers have strived to determine temperature, pressure and other conditions at various locations in a well, such as a gas well. For example, a static bottomhole pressure (SBHP) can be measured directly by pressure gauges placed at the bottom of a well. In some cases, estimates for downhole pressure can be made based on information available at other locations in the well. An example of the information used to provide downhole pressure estimates is the shut-in wellhead pressure. However, estimates may be inaccurate, which can provide false information and can lead to making bad decisions regarding the operation of the well.

### SUMMARY

The present disclosure describes methods and systems, including computer-implemented methods, computer-program products, and computer systems, for determining a static bottomhole pressure (SBHP) from numerical calculations made based on the shut-in wellhead pressure.

In an implementation, an initial value is set for an apparent molecular weight. Iterating occurs on calculations to determine a converged value for the apparent molecular weight, including the following. A specific gas gravity is determined. Pseudo-critical gas properties are determined. A pseudo-reduced gas pressure and temperature are determined. A gas deviation factor is determined using the pseudo-reduced gas properties. An average pressure, an average temperate, and a pressure gradient are determined for each depth interval. A new apparent molecular weight is determined. The absolute value of a relative error between a current value of the apparent molecular weight and the new apparent molecular weight is determined. If the absolute value of the relative error has converged to a constant, the iterating is terminated.

The above-described implementation is implementable using a computer-implemented method; a non-transitory, computer-readable medium storing computer-readable instructions to perform the computer-implemented method; and a computer system comprising a computer memory interoperably coupled with a hardware processor configured to perform the computer-implemented method/the instructions stored on the non-transitory, computer-readable medium.

The subject matter described in this specification can be implemented in particular implementations so as to realize one or more of the following advantages. First, a numerical computerized process can be used to calculate the SBHP of gas wells using surface shut-in pressures. For example, an application that is based on the approach can be accurate, simple-to-use, reservoir-independent, and proven on wide-ranging gas wells. Second, well intervention operations can be minimized in gas wells by utilizing a top-node approach to calculate the SBHP using surface shut-in data, hence, typical risks and associated costs of wireline intervention are eliminated. Third, an apparent molecular weight profiling can be used to obtain representative and accurate results during the calculation stage. Fourth, the apparent molecular weight equation can be formulated and derived as a function of gas pressure gradient data. Fifth, detailed step-by-step algorithms and mathematical equations of the top-node methodology can solve the gas SBHP problem with minimum computational power. For example, analytical equation can be derived that are used to generate the future gas pressure and temperature profiles from the baseline apparent molecular weight profile. Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 portrays a conceptual diagram of apparent molecular weight (MMₐ) profiling, according to an implementation.

FIG. 2 is a flowchart of an example method representing a MMₐ profiling method workflow, according to an implementation.

FIG. 3 shows a conceptual diagram of the top node method for calculating a bottomhole pressure, according to an implementation.

FIG. 4 shows a top node method workflow, according to an implementation.

FIG. 5 is a block diagram of an exemplary computer system used to provide computational functionalities associated with described algorithms, methods, functions, processes, flows, and procedures as described in the instant disclosure, according to an implementation.

Like reference numbers and designations in the various drawings indicate like elements.

### DETAILED DESCRIPTION

This disclosure generally describes methods and systems, including computer-implemented methods, computer-program products, and computer systems, for determining a static bottomhole pressure (SBHP).

The following detailed description is presented to enable any person skilled in the art to make and use the disclosed subject matter in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described or illustrated implementations, but is to be accorded the widest scope consistent with the principles and features disclosed herein.

In order to explain details of the approach, it is first necessary to provide information and equations associated with ideal gasses and their characteristics.

An ideal gas is a hypothetical gas that has the following properties: the volume of the gas molecules is insignificant compared with the total volume of the gas, no attractive or repulsive forces exist among the molecules or between the molecules and the container walls, and all molecules collisions are perfectly elastic.

Boyle's Law and Charles' Law describe the relationship between a volume occupied by a gas and the gas' pressure and temperature. Boyle's Law states that for a given mass of gas at a constant temperature, the pressure-volume product is constant. Charles' Law states that, for a given mass of gas at a constant pressure, the volume/temperature ratio is constant. The combination of the two laws is called the equation of state (EOS) for ideal gases:

PV=nRT, (1)

where P is pressure, for example, in pressure per square inch, absolute (psia), V is volume, for example in ft³, n is a number of moles, R is a Universal Gas Constant:10.732 psia (ft³)/(° R)(lb.-mole), and T is temperature, for example in degrees Rankine.

The behavior of most real gases does not deviate drastically from the behavior predicted by this equation. The EOS for real gases can be obtained by simply adding a correction factor Z to the EOS for ideal gases. This dimensionless factor Z, also called a compressibility factor, accounts for the non-ideal behavior of the real gas. The factor depends on pressure, temperature, and gas composition. Common methods to obtain the value of Z are by laboratory experiment of the sampled gas or using existing mathematical correlations. With the addition of the compressibility factor, the equation becomes:

PV=ZnRT, (2)

where Z is the above-described compressibility factor.

According to properties of a dry gas mixture, since a gas mixture is composed of molecules of various sizes and different molecular weights, the gas mixture does not have an explicit molecular weight. However, the gas mixture can behave as if it has a definite molecular weight, for example, known as the apparent molecular weight (MMₐ) and defined as:

MMₐ=ΣᵢyᵢMᵢ (3)

where MMₐ is the apparent molecular weight, for example in lb/lb-mole, Mᵢ is the molecular weight of ith gas component, for example in lb/lb-mole, Mₐᵢᵣ is the molecular weight of air, which is 28.96, lb/lb-mole, and yᵢ is the mole fraction of a particular component in the gas mixture.

Since density is defined as the mass of gas per unit volume, an equation of state can be used to calculate the densities of a gas at various temperatures and pressures:

$${ρ}_{g} = \frac{m}{v} = \frac{{PMM}_{a}}{ZRT} . \qquad ( 4 )$$

Similarly, gas pressure gradient is calculated as follows:

$${α}_{g} = \frac{{ρ}_{g}}{144} = \frac{{PMM}_{a}}{144 ZRT} , \qquad ( 5 )$$

where ρ_{g} is gas density, lbm/ft3, m is mass, lbm, v is volume, and α_{g} is the gas wellbore pressure gradient.

The specific gravity of a gas is defined as the ratio of the density of the gas to the density of dry air with both measured at the same temperature and pressure:

$$\begin{matrix}{γ}_{g} = \frac{{ρ}_{g}}{{ρ}_{air}} or & ( 6 ) \\ {γ}_{g} = \frac{{M}_{a}}{{M}_{air}} = \frac{{M}_{a}}{28.97} , & ( 7 )\end{matrix}$$

where γ_{g} is the gas specific gravity, Mₐ, is apparent mass, and ρₐᵢᵣ is the dry air density, for example in lb-m/ft³. Note that this equation is strictly true only if both the gas and air act like ideal gases.

The Law of Corresponding States says that all pure gases have the same z-factor at the same values of reduced pressure and reduced temperature. Reduced pressure and reduced temperature for pure compounds are defined as:

Pᵣ=P/P_{c} (8)

and

Tᵣ=T/T_{c}, (9)

where Pᵣ is the reduced pressure, P_{c} is the critical pressure, Tᵣ is the reduced temperature, and T_{c} is the critical temperature, for example in degrees Rankine.

Pseudo-reduced pressure and pseudo-reduced temperature for mixtures are defined, respectively, as:

Ppr=p/Ppc (10)

and

Tpr=T/Tpc, (11)

where Ppr is pseudo-reduced pressure, Ppc is pseudocritical pressure, Tpr is pseudo-reduced temperature, and Tpc is pseudocritical temperature, for example in degrees Rankine.

A well-known graph showing the behavior of Z-factor for hydrocarbon gases is Standing and Katz that shows the behavior of Z-factor for hydrocarbon gases with respect to reduced pressures and reduced temperatures.

There are methods for calculating the pseudocritical pressure and temperature of a hydrocarbon gas mixture which provide a mean value used to correlate the physical properties of mixtures with the Law of Corresponding States. One of these methods is Sutton's Correlations for unknown gas composition. Using data from 264 gas samples, Sutton developed a correlation for estimating pseudocritical pressure and temperature as a function of gas specific gravity:

P_{pch}756.8−131.0γₕ−3.6γₕ² (12)

and

T_{pch}=169.2+349.5γₕ−74.0γₕ², (13)

where P_{pch} is the pseudocritical pressure of hydrocarbon components, for example in psia, T_{pch} is the pseudocritical temperature of hydrocarbon components, R, and γₕ is the specific gravity of hydrocarbon components.

This correlation is applicable for 0.57<γₕ<1.68 and for gas containing <12 mol % CO₂, <3 mol % nitrogen, and no H₂S. However, if the gas contains more than 12 mol % CO₂, greater than 3 mol % nitrogen, or any H₂S, then the gas gravity should be re-calculated by:

$${γ}_{h} = \frac{\begin{matrix}{γ}_{w} - 1.1767 {y}_{{H}_{2} S} - \\ 1.5196 {y}_{{CO}_{2}} - 0.9672 {y}_{{N }_{2}} - 0.6220 {y}_{{H}_{2} O}\end{matrix}}{1 - {y}_{{H}_{2} S} - {y}_{{CO}_{2}} - {y}_{{N}_{2}} - {y}_{{H}_{2} O}} , \qquad ( 14 )$$

where y_{H2S} is the mole fraction of H₂S, y_{CO2} is the mole fraction of CO₂, y_{N2} is the mole fraction of N₂, and y_{H2O} is the mole fraction of H₂O.

The pseudocritical properties can be calculated by the following equations:

P_{pc}==(1−y_{H2S}−y_{CO2}−y_{N2}−_{H2O})P_{pch}+1,306y_{H2S}+1,071y_{CO2}+493.1y_{N2}+3,200.1y_{H2O} (15)

and

T_{pc}==(1−y_{H2S}−y_{CO2}−y_{N2}−_{H2O})T_{pch}+672.35y_{H2S}+547.58y_{CO2}+227.16y_{N2}+1,164.9y_{H2O} (15)

Ideally, static bottomhole pressure (SBHP) is measured directly by pressure gauges placed at the well bottom. However, such measurements might often be impractical. Most SBHP calculation techniques are based on mechanical energy balance that describes steady-state flow in a conduit. For a static vertical gas column, the kinetic energy and friction effects can be eliminated from the energy balance equation to obtain:

$$dp = - \frac{{ρ}_{g}}{144} d L , \qquad ( 17 )$$

where dp is a change in pressure, for example in psia, and dL is a change in length, for example in feet.

Assuming dry gas single phase fluid, the gas density can be expressed as a function of pressure by EOS as discussed above and as following:

$${ρ}_{g} = \frac{{PM}_{a}}{ZRT} = \frac{28.97 P {γ}_{g}}{ZRT} . \qquad ( 18 )$$

Combining the above two equations produces:

$$dp = - \frac{0.01875 {γ}_{g} P}{144 ZT} d L . \qquad ( 19 )$$

Recall that both gas density and Z factor are each a function of pressure and temperature. In addition, wellbore temperature changes with depth. Therefore, solving the above-described differential equation can be challenging. To simplify the solution of the differential equation, average temperature and Z factor can be assumed. In typical implementations, these values are determined at the arithmetic average of the surface and bottomhole temperature and pressure. Substituting an average temperature and average Z factor to above equation results in:

$${\int }_{pws}^{pts} \frac{dp}{p} = - \frac{0.01875 {γ}_{g}}{\overline{Z} \overline{T}} {\int }_{0}^{L} d L , \qquad ( 20 )$$

where L is the flow-string depth, for example in feet, P_{ws} is the bottomhole static pressure, for example in psia, and pₜₛ is the wellhead shut-in pressure, for example in psia. The solution is:

$$\begin{matrix}{P}_{ws} = {p}_{ts} {e}^{s / 2} , where & ( 21 ) \\ s = \frac{0.0375 {γ}_{gL}}{\overline{Z} \overline{T}} . & ( 22 )\end{matrix}$$

Because Z̅ depends on P_{ws}, a solution to equation 21 involves an iterative process. For example, in a typical implementation, a high-level iterative process can be as follows. First, assume a value of SBHP and P_{ws}. Second, compute the arithmetic average pressure and temperature. Third, calculate average Z factor using the average pressure and temperature. Fourth, calculate P_{ws} with above equation. Iterative use of the equations can occur until P_{ws} converges. In some implementations, because of simplifying assumptions made in the development of average temperature and Z-Factor, the calculations may be more applicable to shallow gas wells but may be sufficiently accurate, in general, for all applications.

In some implementations, the following assumptions associated with the equations above and methods/techniques described in this disclosure include the following. The equation of state (EOS) for real gas is applicable for calculating gas densities and corresponding pressure gradients. A change in the gas wellbore temperature profile is negligible within a time-lapse period of five years. MMₐ is a strong function of temperature and corresponding depth and a weak function of pressure. Hence, changes in MMₐ are neglected with time. Usage of Sutton's correlation in calculating the gas mixture pseudo-critical properties as a function of gas specific gravity is applicable in this modeling. Minor effects of gas impurities, such as nitrogen, carbon dioxide, and hydrogen sulfide, are excluded from the calculations made within Sutton's correlation. Standing and Katz gas deviation factor (Z) charts are fairly accurate in the gas wells conditions under study. The overall method is widely applicable to dry gas wells having a pressure gradient of less than 0.19 psi/ft. The applicability of methods/techniques in condensate gas wells is contingent on the following criteria. Wells identified with less than 300 feet of liquid (condensate or water) hold-up in the wellbore are applicable where the liquid column is corrected to the nearest equivalent gas pressure gradient. Wells identified with more than 300 feet of liquid hold-up are outside the scope of this disclosure since the real gas equation of state is no longer applicable.

Baseline gas gradient pressure and temperature surveys can be the cornerstone of the overall methodology to calculate static bottomhole pressure surveys from surface shut-in data. Baseline gradient surveys can be used, for example, to develop wells' specific apparent molecular weight profiles across segmented wellbore intervals.

The profiling of apparent molecular weight in this method uses measured pressure and temperature of a recent gradient surveys to calculate MMₐ corresponding to each segment in the wellbore.

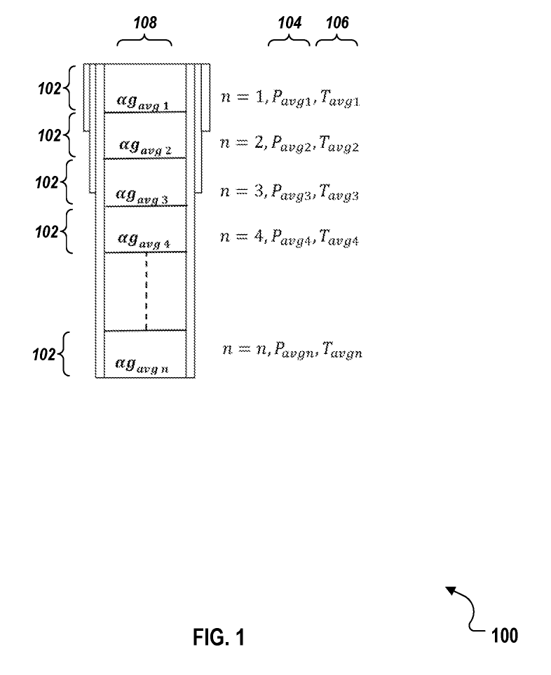

FIG. 1 portrays a conceptual diagram of MMₐ profiling, according to an implementation. In some implementations, the following equations can be used to compute the apparent molecular weight for each depth interval 102 or a wellbore 100. An initial apparent molecular weight MMₐᵢ value of 16.0 gram/lb.-mole can be used as a starting value. The specific gas gravity can be calculated using Equation 7. The pseudo-critical gas properties can be calculated using Sutton's Correlation Equation 12 and Equation 13. The pseudo-reduced gas pressure and temperature can be calculated using Equation 10 and Equation 11. The gas deviation factor (Z) can be determined using Standing and Katz charts using the pseudo-reduced gas properties. The average pressure (P_{avg}) 104, average temperate (T_{avg}) 106, and pressure gradient (α_{g}_{_{avg}}) 108 can be calculated for each depth interval 102 from the most recent gradient survey. A final apparent molecular weight MM_{af} value can be calculated using the following equation:

$${MM}_{af} = \frac{144 {Z}_{avg} {RT}_{avg} {α}_{{g}_{avg}}}{{P}_{avg}} . \qquad ( 23 )$$

The absolute value of the relative error between MMₐᵢ and MM_{af} can be calculated. If absolute value of MM relative error is <=0.001%, then MMₐ has converged, and the next depth interval can be used. If not, 0.001 can be added to MMₐᵢ value, and execution of the equations can be iteratively repeated till convergence.

The above procedure is applied on all available depth intervals in the baseline pressure and temperature survey. Corresponding MMₐ values for each depth interval are used for segmented pressure gradient calculations in subsequent time-lapses to the baseline survey using the top node approach.

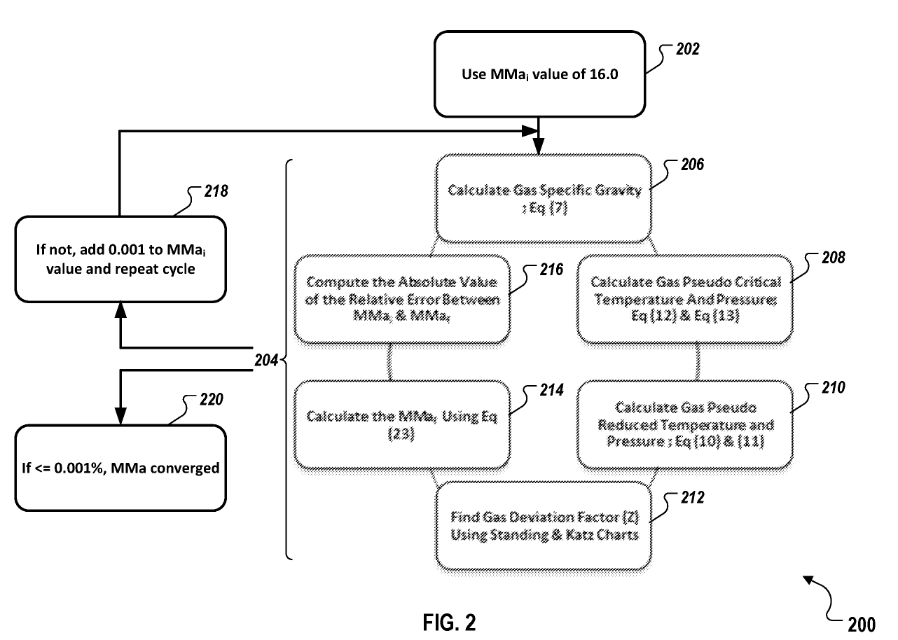

FIG. 2 is a flowchart of an example method 200 representing a MMₐ profiling method workflow, according to an implementation. For example, the method 200 present steps associated with the visualization shown in FIG. 1. In some implementations, calculations for the MMₐ profiling method workflow can include the following computations. For example, segmented depth intervals can be used inside the wellbore according to a recent, such as the latest, pressure and temperature gradient survey. For each segment, the following computations can be performed using the following equations.

At 202, an initial value is set for an apparent molecular weight for a depth interval for a wellbore. For example, an MMₐᵢ value of 16.0 gram/lb.mole can be used as a starting value. From 202, method 200 proceeds to 204.

At 204, an iteration of calculations is used to determine a converged value for the apparent molecular weight. For example, the iteration can occur for steps 206-216. From 204, method 200 proceeds to 206.

At 206, a specific gas gravity is determined. For example, the specific gas gravity can be calculated using:

$${γ}_{g} = \frac{{MM}_{ai}}{{M}_{air}} = \frac{{MM}_{ai}}{28.97} . \qquad ( 24 )$$

From 206, method 200 proceeds to 208.

At 208, pseudo-critical gas properties are determined. For example, the pseudo-critical gas properties can be calculated using Sutton's Correlation:

P_{pch}=756.8−131.0γₕ−3.6γₕ² (25a)

and

T_{pch}=169.2+349.5γₕ−74.0γₕ². (25b)

From 208, method 200 proceeds to 210.

At 210, a pseudo-reduced gas pressure and temperature are determined. For example, the pseudo-reduced gas pressure and temperature can be calculated using the following equations:

Ppr=p/Ppc (26)

and

Tpr=T/Tpc. (27)

From 210, method 200 proceeds to 212.

At 212, a gas deviation factor is determined using the pseudo-reduced gas properties. For example, the Z-factor can be determined from the Standing and Katz chart as a function of pseudo-reduced pressure and temperature. The average pressure (P_{avg}), temperature (T_{avg}), and pressure gradient (α_{g}_{_{avg}}) are computed for each depth interval. From 212, method 200 proceeds to 214.

At 214, a new apparent molecular weight is calculated. For example, the MM_{af} value is calculated using the following equation:

$${MM}_{af} = \frac{144 {Z}_{avg} {RT}_{avg} {α}_{{g}_{avg}}}{{P}_{avg}} . \qquad ( 28 )$$

From 214, method 200 proceeds to 216.

At 216, the absolute value is determined of a relative error between a current value of the apparent molecular weight and the new apparent molecular weight. For example, the absolute value of the relative error between the MMₐᵢ and MM_{af} can be computed using the following equation:

$$Error \% = \frac{\vert {MM}_{ai} ( current ) - {MM}_{af} ( Equation 28 )}{{MM}_{af} ( Equation 28 )} \times 100. \qquad ( 29 )$$

From 216, method 200 proceeds to 218.

At 218, a determination is made if the absolute value of the relative error has converged to a constant, such as 0.001%, indicating that the relative error is within an error tolerance. If the absolute value of the relative error has not converged to a constant, then the iterations at 204 can continue, and a constant such as 0.001 can be added to the MMₐᵢ value. From 218, method 200 proceeds to 206.

At 220, the iterating is terminated upon determination that the relative error has converged to the constant. For example, if the absolute value of the relative error is <=0.001%, then the MMₐ value has converged for the current depth level, and method 200 can be used at the next depth interval. From 218, method 200 stops.

The top node approach uses an arbitrary number of segments within the gas column in the wellbore. Generally, the more the wellbore is segmented, the more accurate the results are. For each segment in the wellbore, the upper pressure and temperature values are referred to as top node parameters.

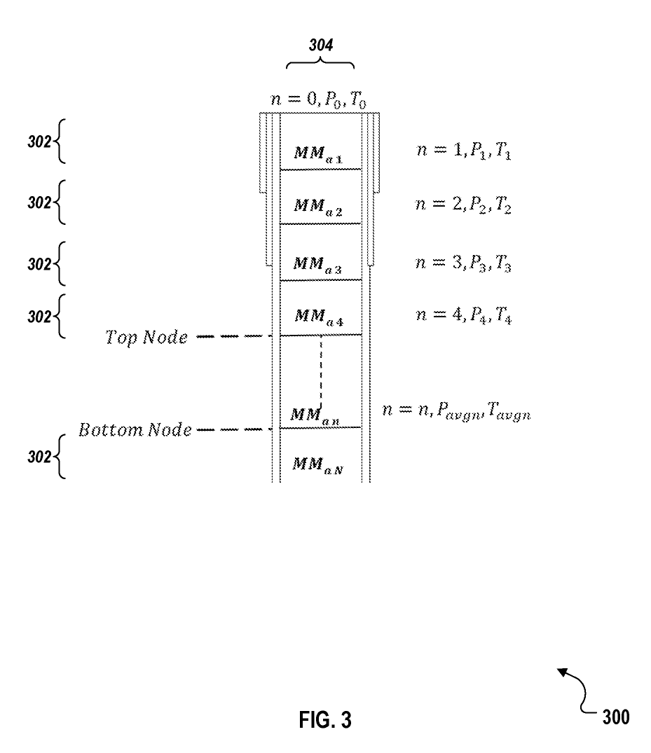

FIG. 3 shows a conceptual diagram of the top node method for calculating a bottomhole pressure, according to an implementation. In some implementations, the top node method can use MMₐₙ values 304 for each of n depth intervals 302. For example, the MMₐ values generated from the MMₐ profiling described above can be used as inputs for corresponding depth segments in the top node method. For example, Equation (5) can be applied to each segment to calculate the segment average pressure gradient. This average pressure gradient can be used to compute the incremental gravitational pressure, such as ΔP gravity. Then, the incremental gravitational pressure can be added to the previous reference pressure (Top Node pressure) to obtain the pressure at the bottom of the segment. These segmental calculations can be repeated until the bottomhole depth is reached. Using the MMₐₙ values 304, the following equation can be used to determine P_{R}:

$${P}_{R} = {P}_{N} = {P}_{0} + {\sum }_{n = 1}^{N} \frac{{P}_{n - 1} {MM}_{n}}{144 {Z}_{n} {RT}_{n - 1}} , \qquad ( 30 )$$

where P_{R} is the bottomhole pressure, P_{N} is the final SBHP, which is the summation of all incremental nodes from segment#0 to segment#N, and P₀ is the top node pressure at segment#0.

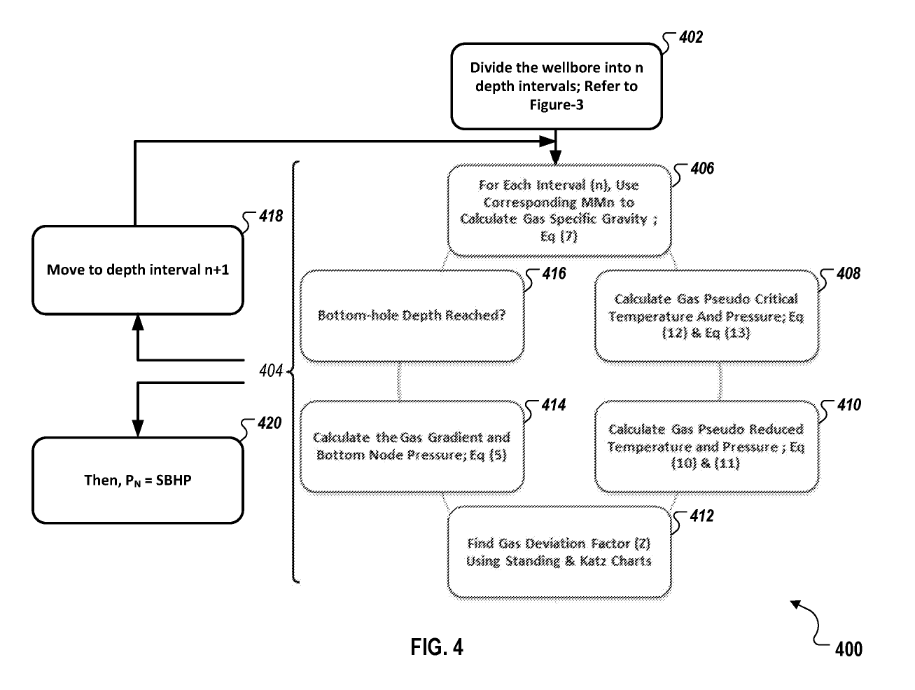

FIG. 4 shows a top node method workflow, according to an implementation. In some implementations, the workflow includes the following calculations. For example, the method 400 present steps associated with the visualization shown in FIG. 3. The same segmented depth intervals can be used inside the wellbore obtained from the apparent molecular weight profiling, such as the workflow calculations described above with reference to FIG. 2. Each depth interval inside the wellbore has a top node and a bottom node. The top node is known when starting the calculation from the known shut-in wellhead pressure. The bottom node is calculated by adding the top node pressure to the gas gradient corresponding to each interval. These calculations can continue for all wellbore depth intervals until the bottomhole depth is reached. In some implementations, the following computations can be performed for each segment.

At 402, a wellbore is divided into plural depth intervals. For example, the MM_{af} value corresponding to each depth interval is calculated, such as using Equation 28. From 402, method 400 proceeds to 404.

At 404, an iteration of calculations is used to determine a bottomhole pressure. For example, the iteration can occur for steps 406-416. From 404, method 400 proceeds to 406.

At 406, a specific gas gravity is determined. For example, the specific gas gravity can be calculated using:

$${γ}_{g} = \frac{{MM}_{af}}{{M}_{air}} = \frac{{MM}_{af}}{28.97} . \qquad ( 31 )$$

From 406, method 400 proceeds to 408.

At 408, pseudo-critical gas properties are determined. For example, the pseudo-critical gas properties can be calculated using Sutton's Correlation:

P_{pch}=756.8−131.0γₕ−3.6γₕ² (32)

and

T_{pch}=169.2+349.5γₕ−74.0γₕ² (33)

From 408, method 400 proceeds to 410.

At 410, a pseudo-reduced gas pressure and temperature are determined. For example, the pseudo-reduced gas pressure and temperature can be calculated using:

Ppr=p/Ppc (34)

and

Tpr=T/Tpc. (35)

From 410, method 400 proceeds to 412.

At 412, a gas deviation factor is determined using the pseudo-reduced gas properties. For example, Z-factor can be determined from Standing and Katz chart as a function of pseudo-reduced pressure and temperature. From 412, method 400 proceeds to 414.

At 414, a gas gradient and a bottom node pressure are determined. For example, the gas gradient corresponding to each depth interval can be calculated using the following equation:

$${α}_{g} = \frac{{ρ}_{g}}{144} = \frac{{PMM}_{a}}{144 ZRT} , \qquad ( 36 )$$

From 414, method 400 proceeds to 416.

At 416, a determination is made whether the bottomhole depth has been reached. It the bottomhole depth has not been reached, then processing can move to the next depth interval and calculation can continue, and method 400 proceeds to 406. If the bottomhole depth has been reached, then method 400 proceeds to 420.

At 420, the determined bottom node pressure is used as a static bottomhole pressure. For example, P_{N}=SBHP.

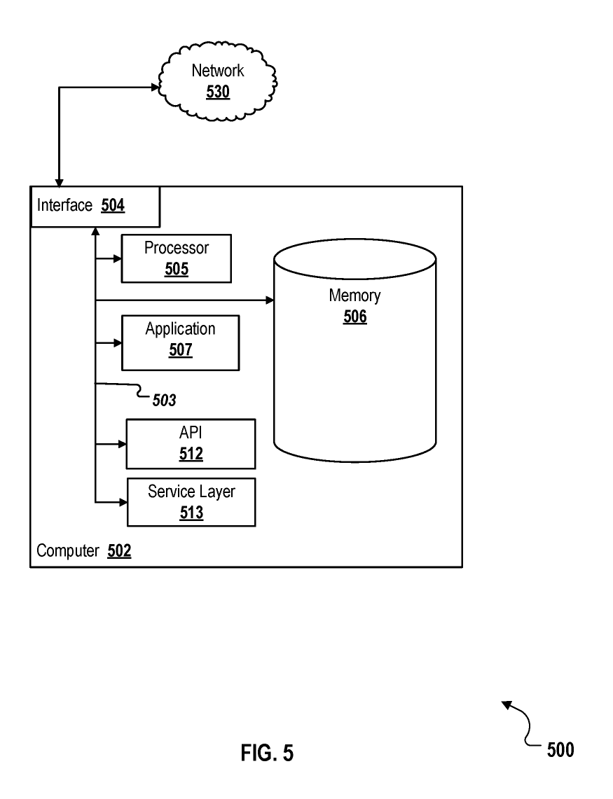

FIG. 5 is a block diagram of an exemplary computer system 500 used to provide computational functionalities associated with described algorithms, methods, functions, processes, flows, and procedures as described in the instant disclosure, according to an implementation. The illustrated computer 502 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 502 may comprise a computer that includes an input device, such as a keypad, keyboard, touch screen, or other device that can accept user information, and an output device that conveys information associated with the operation of the computer 502, including digital data, visual, or audio information (or a combination of information), or a GUI.

The computer 502 can serve in a role as a client, network component, a server, a database or other persistency, or any other component (or a combination of roles) of a computer system for performing the subject matter described in the instant disclosure. The illustrated computer 502 is communicably coupled with a network 530. In some implementations, one or more components of the computer 502 may be configured to operate within environments, including cloud-computing-based, local, global, or other environment (or a combination of environments).

At a high level, the computer 502 is an electronic computing device operable to receive, transmit, process, store, or manage data and information associated with the described subject matter. According to some implementations, the computer 502 may also include or be communicably coupled with an application server, e-mail server, web server, caching server, streaming data server, business intelligence (BI) server, or other server (or a combination of servers).

The computer 502 can receive requests over network 530 from a client application (for example, executing on another computer 502) and responding to the received requests by processing the said requests in an appropriate software application. In addition, requests may also be sent to the computer 502 from internal users (for example, from a command console or by other appropriate access method), external or third-parties, other automated applications, as well as any other appropriate entities, individuals, systems, or computers.

Each of the components of the computer 502 can communicate using a system bus 503. In some implementations, any or all of the components of the computer 502, both hardware or software (or a combination of hardware and software), may interface with each other or the interface 504 (or a combination of both) over the system bus 503 using an application programming interface (API) 512 or a service layer 513 (or a combination of the API 512 and service layer 513). The API 512 may include specifications for routines, data structures, and object classes. The API 512 may be either computer-language independent or dependent and refer to a complete interface, a single function, or even a set of APIs. The service layer 513 provides software services to the computer 502 or other components (whether or not illustrated) that are communicably coupled to the computer 502. The functionality of the computer 502 may be accessible for all service consumers using this service layer. Software services, such as those provided by the service layer 513, provide reusable, defined business functionalities through a defined interface. For example, the interface may be software written in JAVA, C++, or other suitable language providing data in extensible markup language (XML) format or other suitable format. While illustrated as an integrated component of the computer 502, alternative implementations may illustrate the API 512 or the service layer 513 as stand-alone components in relation to other components of the computer 502 or other components (whether or not illustrated) that are communicably coupled to the computer 502. Moreover, any or all parts of the API 512 or the service layer 513 may be implemented as child or sub-modules of another software module, enterprise application, or hardware module without departing from the scope of this disclosure.

The computer 502 includes an interface 504. Although illustrated as a single interface 504 in FIG. 5, two or more interfaces 504 may be used according to particular needs, desires, or particular implementations of the computer 502. The interface 504 is used by the computer 502 for communicating with other systems in a distributed environment that are connected to the network 530 (whether illustrated or not). Generally, the interface 504 comprises logic encoded in software or hardware (or a combination of software and hardware) and operable to communicate with the network 530. More specifically, the interface 504 may comprise software supporting one or more communication protocols associated with communications such that the network 530 or interface's hardware is operable to communicate physical signals within and outside of the illustrated computer 502.

The computer 502 includes a processor 505. Although illustrated as a single processor 505 in FIG. 5, two or more processors may be used according to particular needs, desires, or particular implementations of the computer 502. Generally, the processor 505 executes instructions and manipulates data to perform the operations of the computer 502 and any algorithms, methods, functions, processes, flows, and procedures as described in the instant disclosure.

The computer 502 also includes a memory 506 that holds data for the computer 502 or other components (or a combination of both) that can be connected to the network 530 (whether illustrated or not). For example, memory 506 can be a database storing data consistent with this disclosure. Although illustrated as a single memory 506 in FIG. 5, two or more memories may be used according to particular needs, desires, or particular implementations of the computer 502 and the described functionality. While memory 506 is illustrated as an integral component of the computer 502, in alternative implementations, memory 506 can be external to the computer 502.

The application 507 is an algorithmic software engine providing functionality according to particular needs, desires, or particular implementations of the computer 502, particularly with respect to functionality described in this disclosure. For example, application 507 can serve as one or more components, modules, applications, etc. Further, although illustrated as a single application 507, the application 507 may be implemented as multiple applications 507 on the computer 502. In addition, although illustrated as integral to the computer 502, in alternative implementations, the application 507 can be external to the computer 502.

There may be any number of computers 502 associated with, or external to, a computer system containing computer 502, each computer 502 communicating over network 530. Further, the term “client,” “user,” and other appropriate terminology may be used interchangeably as appropriate without departing from the scope of this disclosure. Moreover, this disclosure contemplates that many users may use one computer 502, or that one user may use multiple computers 502.

Described implementations of the subject matter can include one or more features, alone or in combination.

For example, in a first implementation, a computer-implemented method computer-implemented method, comprising: setting an initial value for an apparent molecular weight for a depth interval for a wellbore; and iterating on calculations to determine a converged value for the apparent molecular weight, including: determining a specific gas gravity; determining pseudo-critical gas properties; determining a pseudo-reduced gas pressure and temperature; determining a gas deviation factor using the pseudo-reduced gas properties; determining an average pressure, an average temperate, and an pressure gradient for each depth interval; determining a new apparent molecular weight; determining the absolute value of a relative error between a current value of the apparent molecular weight and the new apparent molecular weight; determining if the absolute value of the relative error has converged to a constant; and terminating the iterating upon determination that the relative error has converged to the constant.

The foregoing and other described implementations can each optionally include one or more of the following features:

A first feature, combinable with any of the following features, wherein determining the specific gas gravity includes using an equation given by:

$${γ}_{g} = \frac{{M}_{a}}{{M}_{air}} = \frac{{M}_{a}}{28.97} ,$$

and wherein γ_{g} is the gas specific gravity, Mₐ is the molecular weight of gas, and Mₐᵢᵣ is the molecular weight of air.

A second feature, combinable with any of the previous or following features, wherein determining the pseudo-critical gas properties includes using equations given by: P_{pch}=756.8−131.0γₕ−3.6γₕ² and T_{pch}=169.2+349.5γₕ−74.0ₕ², and wherein P_{pch} is the pseudocritical pressure of hydrocarbon components, T_{pch} is the pseudocritical temperature of hydrocarbon components, and γₕ is the specific gravity of hydrocarbon components.

A third feature, combinable with any of the previous or following features, wherein determining the pseudo-reduced gas pressure and temperature includes using equations given by: Ppr=p/Ppc and Tpr=T/Tpc, and wherein Ppr is pseudo-reduced pressure, Ppc is pseudocritical pressure, Tpr is pseudo-reduced temperature, Tpc is pseudocritical temperature, p is pressure, and T is temperature.

A fourth feature, combinable with any of the previous or following features, wherein determining the new apparent molecular weight MM_{af} includes using an equation given by:

$${MM}_{af} = \frac{144 {Z}_{avg} {RT}_{avg} {α}_{{g}_{avg}}}{{P}_{avg}} ,$$

and wherein Z_{avg} is an average Z factor, R is the Universal Gas Constant, T_{avg} is an average temperature, α_{g}_{_{avg}} pressure gradient, and P_{avg} is an average pressure.

In a second implementation, a non-transitory, computer-readable medium storing computer-readable instructions executable by a computer and configured to: set an initial value for an apparent molecular weight for a depth interval for a wellbore; and iterate on calculations to determine a converged value for the apparent molecular weight, including: determining a specific gas gravity; determining pseudo-critical gas properties; determining a pseudo-reduced gas pressure and temperature; determining a gas deviation factor using the pseudo-reduced gas properties; determining an average pressure, an average temperate, and an pressure gradient for each depth interval; determining a new apparent molecular weight; determining the absolute value of a relative error between a current value of the apparent molecular weight and the new apparent molecular weight; determining if the absolute value of the relative error has converged to a constant; and terminating the iterating upon determination that the relative error has converged to the constant.

The foregoing and other described implementations can each optionally include one or more of the following features:

A first feature, combinable with any of the following features, wherein determining the specific gas gravity includes using an equation given by:

$${γ}_{g} = \frac{{M}_{a}}{{M}_{air}} = \frac{{M}_{a}}{28.97} ,$$

and wherein γ_{g} is the gas specific gravity, Mₐ is the molecular weight of gas, and Mₐᵢᵣ is the molecular weight of air.

A second feature, combinable with any of the previous or following features, wherein determining the pseudo-critical gas properties includes using equations given by: P_{pch}=756.8−131.0γₕ−3.6γₕ² and T_{pch}=169.2+349.5γₕ−74.0γₕ², and wherein P_{pch} is the pseudocritical pressure of hydrocarbon components, T_{pch} is the pseudocritical temperature of hydrocarbon components, and γₕ is the specific gravity of hydrocarbon components.

A third feature, combinable with any of the previous or following features, wherein determining the pseudo-reduced gas pressure and temperature includes using equations given by: Ppr=p/Ppc and Tpr=T/Tpc, and wherein Ppr is pseudo-reduced pressure, Ppc is pseudocritical pressure, Tpr is pseudo-reduced temperature, Tpc is pseudocritical temperature, p is pressure, and T is temperature.

A fourth feature, combinable with any of the previous or following features, wherein determining the new apparent molecular weight MM_{af} includes using an equation given by:

$${MM}_{af} = \frac{144 {Z}_{avg} {RT}_{avg} {α}_{{g}_{avg}}}{{P}_{avg}} ,$$

and wherein Z_{avg} is an average Z factor, R is the Universal Gas Constant, T_{avg} is an average temperature, α_{g}_{_{avg}} pressure gradient, and P_{avg} is an average pressure.

In a third implementation, a computer-implemented system, comprising: at least one computer interoperably coupled with a memory storage and configured to: set an initial value for an apparent molecular weight for a depth interval for a wellbore; and iterate on calculations to determine a converged value for the apparent molecular weight, including: determining a specific gas gravity; determining pseudo-critical gas properties; determining a pseudo-reduced gas pressure and temperature; determining a gas deviation factor using the pseudo-reduced gas properties; determining an average pressure, an average temperate, and an pressure gradient for each depth interval; determining a new apparent molecular weight; determining the absolute value of a relative error between a current value of the apparent molecular weight and the new apparent molecular weight; determining if the absolute value of the relative error has converged to a constant; and terminating the iterating upon determination that the relative error has converged to the constant.

The foregoing and other described implementations can each optionally include one or more of the following features:

A first feature, combinable with any of the following features, wherein determining the specific gas gravity includes using an equation given by:

$${γ}_{g} = \frac{{M}_{a}}{{M}_{air}} = \frac{{M}_{a}}{28.97} ,$$

and wherein γ_{g} is the gas specific gravity, Mₐ is the molecular weight of gas, and Mₐᵢᵣ is the molecular weight of air.

A second feature, combinable with any of the previous or following features, wherein determining the pseudo-critical gas properties includes using equations given by: P_{pch}=756.8−131.0γₕ−3.6γₕ² and T_{pch}=169.2+349.5γₕ−74.0γₕ², and wherein P_{pch} is the pseudocritical pressure of hydrocarbon components, T_{pch} is the pseudocritical temperature of hydrocarbon components, and γₕ is the specific gravity of hydrocarbon components.

A third feature, combinable with any of the previous or following features, wherein determining the pseudo-reduced gas pressure and temperature includes using equations given by: Ppr=p/Ppc and Tpr=T/Tpc, and wherein Ppr is pseudo-reduced pressure, Ppc is pseudocritical pressure, Tpr is pseudo-reduced temperature, Tpc is pseudocritical temperature, p is pressure, and T is temperature.

A fourth feature, combinable with any of the previous or following features, wherein determining the new apparent molecular weight MM_{af} includes using an equation given by:

$${MM}_{af} = \frac{144 {Z}_{avg} {RT}_{avg} {α}_{{g}_{avg}}}{{P}_{avg}} ,$$

and wherein Z_{avg} is an average Z factor, R is the Universal Gas Constant, T_{avg} is an average temperature, α_{g}_{_{avg}} pressure gradient, and P_{avg} is an average pressure.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively or in addition, the program instructions can be encoded on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware or software (or a combination of hardware and software), may interface with each other or the interface using an application programming interface (API) or a service layer (or a combination of API and service layer). The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in extensible markup language (XML) format or other suitable format. The API or service layer (or a combination of the API and the service layer) may be an integral or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described above should not be understood as requiring such separation or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

Furthermore, any claimed implementation below is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
setting an initial value for an apparent molecular weight for a depth interval for a wellbore; and
iterating on calculations to determine a converged value for the apparent molecular weight, including:
determining a specific gas gravity;
determining pseudo-critical gas properties;
determining a pseudo-reduced gas pressure and temperature;
determining a gas deviation factor using the pseudo-reduced gas properties;
determining an average pressure, an average temperate, and an pressure gradient for each depth interval;
determining a new apparent molecular weight;
determining the absolute value of a relative error between a current value of the apparent molecular weight and the new apparent molecular weight;
determining if the absolute value of the relative error has converged to a constant; and
terminating the iterating upon determination that the relative error has converged to the constant.

2. The computer-implemented method of claim 1, wherein determining the specific gas gravity includes using an equation given by:
$${γ}_{g} = \frac{{M}_{a}}{{M}_{air}} = \frac{{M}_{a}}{28.97} ,$$
and wherein γ_{g} is the gas specific gravity, Mₐ is the molecular weight of gas, and Mₐᵢᵣ is the molecular weight of air.

3. The computer-implemented method of claim 1, wherein determining the pseudo-critical gas properties includes using equations given by:
P_{pch}=756.8−131.0γₕ−3.6γₕ²
and
T_{pch}=169.2+349.5γₕ−74.0γₕ²,
and wherein P_{pch} is the pseudocritical pressure of hydrocarbon components, T_{pch} is the pseudocritical temperature of hydrocarbon components, and γₕ is the specific gravity of hydrocarbon components.

4. The computer-implemented method of claim 1, wherein determining the pseudo-reduced gas pressure and temperature includes using equations given by:
Ppr=p/Ppc
and
Tpr=T/Tpc,
and wherein Ppr is pseudo-reduced pressure, Ppc is pseudocritical pressure, Tpr is pseudo-reduced temperature, Tpc is pseudocritical temperature, p is pressure, and T is temperature.

5. The computer-implemented method of claim 1, wherein determining the new apparent molecular weight MM_{af} includes using an equation given by:
$${MM}_{af} = \frac{144 {Z}_{avg} {RT}_{avg} {α}_{{g}_{avg}}}{{P}_{avg}} ,$$
and wherein Z_{avg} is an average Z factor, R is the Universal Gas Constant, T_{avg} is an average temperature, α_{g}_{_{avg}} is a pressure gradient, and P_{avg} is an average pressure.

6. A non-transitory, computer-readable medium storing computer-readable instructions executable by a computer and configured to:
set an initial value for an apparent molecular weight for a depth interval for a wellbore; and
iterate on calculations to determine a converged value for the apparent molecular weight, including:
determining a specific gas gravity;
determining pseudo-critical gas properties;
determining a pseudo-reduced gas pressure and temperature;
determining a gas deviation factor using the pseudo-reduced gas properties;
determining an average pressure, an average temperate, and an pressure gradient for each depth interval;
determining a new apparent molecular weight;
determining the absolute value of a relative error between a current value of the apparent molecular weight and the new apparent molecular weight;
determining if the absolute value of the relative error has converged to a constant; and
terminating the iterating upon determination that the relative error has converged to the constant.

7. The non-transitory, computer-readable medium of claim 6, wherein determining the specific gas gravity includes using an equation given by:
$${γ}_{g} = \frac{{M}_{a}}{{M}_{air}} = \frac{{M}_{a}}{28.97} ,$$
and wherein γ_{g} is the gas specific gravity, Mₐ is the molecular weight of gas, and Mₐᵢᵣ is the molecular weight of air.

8. The non-transitory, computer-readable medium of claim 6, wherein determining the pseudo-critical gas properties includes using equations given by:
P_{pch}=756.8−131.0γₕ−3.6γₕ²
and
T_{pch}=169.2+349.5γₕ−74.0γₕ²,
and wherein P_{pch} is the pseudocritical pressure of hydrocarbon components, T_{pch} is the pseudocritical temperature of hydrocarbon components, and γₕ is the specific gravity of hydrocarbon components.

9. The non-transitory, computer-readable medium of claim 6, wherein determining the pseudo-reduced gas pressure and temperature includes using equations given by:
Ppr=p/Ppc
and
Tpr=T/Tpc,
and wherein Ppr is pseudo-reduced pressure, Ppc is pseudocritical pressure, Tpr is pseudo-reduced temperature, Tpc is pseudocritical temperature, p is pressure, and T is temperature.

10. The non-transitory, computer-readable medium of claim 6, wherein determining the new apparent molecular weight MM_{af} includes using an equation given by:
$${MM}_{af} = \frac{144 {Z}_{avg} {RT}_{avg} {α}_{{g}_{avg}}}{{P}_{avg}} ,$$
and wherein Z_{avg} is an average Z factor, R is the Universal Gas Constant, T_{avg} is an average temperature, α_{g}_{_{avg}} is a pressure gradient, and P_{avg} is an average pressure.

11. A computer-implemented system, comprising:
at least one computer interoperably coupled with a memory storage and configured to:
set an initial value for an apparent molecular weight for a depth interval for a wellbore; and
iterate on calculations to determine a converged value for the apparent molecular weight, including:
determining a specific gas gravity;
determining pseudo-critical gas properties;
determining a pseudo-reduced gas pressure and temperature;
determining a gas deviation factor using the pseudo-reduced gas properties;
determining an average pressure, an average temperate, and an pressure gradient for each depth interval;
determining a new apparent molecular weight;
determining the absolute value of a relative error between a current value of the apparent molecular weight and the new apparent molecular weight;
determining if the absolute value of the relative error has converged to a constant; and
terminating the iterating upon determination that the relative error has converged to the constant.

12. The computer-implemented system of claim 11, wherein determining the specific gas gravity includes using an equation given by:
$${γ}_{g} = \frac{{M}_{a}}{{M}_{air}} = \frac{{M}_{a}}{28.97} ,$$
and wherein γ_{g} is the gas specific gravity, Mₐ is the molecular weight of gas, and Mₐᵢᵣ is the molecular weight of air.

13. The computer-implemented system of claim 11, wherein determining the pseudo-critical gas properties includes using equations given by:
P_{pch}=756.8−131.0γₕ−3.6γₕ²
and
T_{pch}=169.2+349.5γₕ−74.0γₕ²,
and wherein P_{pch} is the pseudocritical pressure of hydrocarbon components, T_{pch} is the pseudocritical temperature of hydrocarbon components, and γₕ is the specific gravity of hydrocarbon components.

14. The computer-implemented system of claim 11, wherein determining the pseudo-reduced gas pressure and temperature includes using equations given by:
Ppr=p/Ppc
and
Tpr=T/Tpc,
and wherein Ppr is pseudo-reduced pressure, Ppc is pseudocritical pressure, Tpr is pseudo-reduced temperature, Tpc is pseudocritical temperature, p is pressure, and T is temperature.

15. The computer-implemented system of claim 11, wherein determining the new apparent molecular weight MM_{af} includes using an equation given by:
$${MM}_{af} = \frac{144 {Z}_{avg} {RT}_{avg} {α}_{{g}_{avg}}}{{P}_{avg}} ,$$
wherein Z_{avg} is an average Z factor, R is the Universal Gas Constant, T_{avg} is an average temperature, α_{g}_{_{avg}} is a pressure gradient, and P_{avg} is an average pressure.
